(19) United States
(12) Patent Application Publication
(10) Pub. No.: US 2021/0365917 A1
(43) Pub. Date: Nov. 25, 2021

(54) Tray for Selling Products in Hotel Rooms

(71) Applicant: Shlomo Tusia Cohen, Herzelia (IL)

(72) Inventor: Shlomo Tusia Cohen, Herzelia (IL)

(21) Appl. No.: 17/396,706

(22) Filed: Aug. 8, 2021

Related U.S. Application Data
(63) Continuation-in-part of application No. 16/787,060, filed on Feb. 11, 2020.

(51) Int. Cl. G06Q 20/20; B65D 25/10; B65D 1/34

(52) U.S. Cl. CPC G06Q 20/208; G06Q 50/12; B65D 1/34; B65D 25/108

(57) ABSTRACT

A sales tray for hotel rooms that include a top panel with ten rows of holes when each row has ten holes, a base on which the top panel is assembled, four sensors that detect whether an object is placed over them, nine demarcators that enable the user to demarcate around each sensor a quadrangular area in a size that correspond with a packaging of a specific product, and to demarcate separately around each of said sensors four quadrangular areas in different sizes that correspond with packaging of four different products. The user can associate these four different products with packaging in different sizes to the four rectangular areas, and to associate each sensor to a particular product, by that enabling the user to monitor at the same time a removal of each product.

### RELATED APPLICATIONS

This application is a continuation in part of U.S. patent application Ser. No. 16/787,060 filed on Feb. 11, 2020.

### TECHNICAL FIELD

The present invention refers to a tray for selling products in hotel rooms.

### BACKGROUND ART

Portable trays are widely used to facilitate easy access to and easy tracking of items. Almost every institution employs many types of portable trays. Common examples are bed trays, tool trays, and medical trays. For hotels, a computerized tray is a good tool to provide high quality and fast service with relatively small amounts of labor. The tray may interface with other computerized tools, for example, inventory control, accounting, advertising, and delivering information to customers. A tray with these functions may reduce the need for other hardware and burdensome tasks that would otherwise tax hotel workers. The description above is presented as a general overview of related art in this field and should not be construed as an admission that any of the information it contains constitutes prior art against the present patent application. The present intention provides a tray with some advantages.

### SUMMARY OF THE INVENTION

This summary is provided to introduce a selection of concepts in a simplified form that are further described below in the detailed description. This summary is not intended to identify key features or essential features of the claimed subject matter, nor is it intended to be used to limit the scope of the claimed subject matter.

We present here smart trays with unique designs for displaying and selling commodities. The latter may also be referred to as “products”. In general, these commodities/products are items that are saleable and may have various shapes and sizes. These trays are universal trays, i.e., each has a design that accommodates products of widely varying shape and size, not limited to any specific material nor requiring tray-specific design features. A tray user, such as a hotel, can choose the displayed products without worrying about incompatibility with the tray.

In some embodiments the tray also has an innovative design that makes it possible to place the tray anywhere in the room, regardless of the power supply limitations/locations in the room, whether on a table or shelf and/or a refrigerator, giving it great flexibility as per location and visibility.

In some embodiments, the smart tray includes an electronic smart card or PCB that can allow constant or frequent scanning of the accommodated marketed products. In some embodiments, the scanning can be toggled between continuous and intermittent scanning; in some other embodiments, the scanning is only continuous; and in some other embodiments, the scanning is only intermittent.

In some embodiments, a smart tray can transmit alerts in real-time to a cloud management system to monitor commodity movements and changes.

In some embodiments, management software of the smart card/PCB interfaces with a computerized hotel management system and relays information about changes made to the smart tray in the room; in some embodiments, this is carried out in real time, and the product is automatically charged to the guest.

In some embodiments, the tray may be placed in multiple rooms in the hotel.

In some embodiments, the tray may be very thin; In some embodiments, the tray may be designed to be inconspicuous; In some embodiments, the tray may be designed to be conspicuous and aesthetically appealing; In some embodiments, pictures and text may be inscribed on exterior of the tray, such as the names and/or symbols of a hotel.

According to one aspect, a smart tray is provided for displaying and selling commodities, wherein the tray has at least one panel, and is adaptable to a size and a shape of at least one commodity such that each of the at least one panel can engage with the at least one commodity. In principle the trays are designed to allow accommodation of any vended article.

In some embodiments at least one of the at least one panel includes: At least one slot, and the tray further comprises at least one tray holder, each holder having: at least one peg sized to fit into one of the at least one slot or hole, and an engagement region, wherein the engagement region extends out from the panel when the at least one peg is engaged with the at least one slot or hole.

In some embodiments, each holder comprises at least two pegs.

In some embodiments the panel comprises at least one essentially flat commodity-bearing surface, and each engagement region comprises: a corner; and at least two wings extending from the corner; wherein the corner and at least two wings of a holder define a commodity-engaging surface that extends out from one of the commodity-bearing surfaces when the at least one peg of the holder is engaged with the at least one hole.

In some embodiments, at least one commodity-engaging surface is concave.

In some embodiments, at least one commodity-engaging surface is essentially perpendicular to one of the commodity-bearing surfaces when the at least one peg of the holder is engaged with the at least one hole.

In some embodiments, the wings of at least one holder each comprise a straight side. In some embodiments, at least one of the holders comprises three wings wherein the holder is T-shaped. In some embodiments, at least one of the holders comprises four wings, wherein the holder is cross-shaped. In some embodiments, the pegs of at least one holder extend from the corner or from regions in between the corner and the wings. In some embodiments, there is at least one lock for locking at least one holder to at least one panel. In some of these embodiments the lock is remotely operable.

In some embodiments, the at least one peg is hour-glass shaped and comprises a neck, wherein the neck extends throughout the slot when the at least one peg is engaged with the at least one slot.

Some embodiments further comprise at least one lock for locking at least one holder to the at least one panel such that the holder is immovable in the at least one slot. In some embodiments, the at least one lock is remotely operable. In some embodiments, the tray is programmable to allow remote moving of the at least one holder along the at least one slot.

Some embodiments further comprise: at least one tray base, each base essentially matching in size and shape to one of the panels, and an electronic smart card and/or PCB hidden between at least one tray base and at least one matching panel, each card and/or PCB allowing constantly or frequently scanning movements of commodities engaged with at least one panel and/or at least one holder, and transmitting real-time alerts to a cloud management system to identify said movements.

In some embodiments the tray is situated in a guest room and is connected with management software associated with the smart card/PCB, the management software capable of interfacing with a hotel system and updating every change made to the smart tray, the changes including movement of at least some of the commodities in real time, wherein the commodity is subsequently automatically charged to the guest room.

In some embodiments, the tray can be placed anywhere in a room, regardless of the existence and placement of a power supply in the room.

In some embodiments, the panel further comprises: material transparent to a radiation; means for irradiating the panel where the radiation-transparent material is situated therein or thereon, and means for detecting the irradiated radiation after the irradiated radiation passes through the radiation-transparent material.

### BRIEF DESCRIPTION OF THE DRAWINGS

The figures illustrate generally, by way of example, but not by way of limitation, various embodiments discussed in the present document. For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below. The number of elements shown in the Figures should not be construed as limiting, and is for illustrative purposes only.

FIG. 1 is an elevated perspective exploded view of a tray embodiment.

FIG. 2 is a lowered perspective exploded view of the same tray.

FIG. 3 is an elevated perspective enlarged view of tray holders and a tray embodiment with holes.

FIG. 4 is an elevated perspective enlarged view of tray holders and a tray embodiment with slots.

FIG. 5 is an elevated perspective enlarged view of holders comprising three wings perpendicular to each other.

FIG. 6 is an elevated perspective enlarged view of cross-shape holders.

FIG. 7 is an enlarged lower view of tray holders and a tray embodiment with holes and at least one lock for locking at least one holder to the at least one panel.

FIG. 8 illustrates the tray (100) with its four sensors.

FIGS. 9a, 9b, 9c and 9d depict illustrate kinds of products (20a) (20b) (20c) (20d).

FIG. 10 illustrates the tray (100) with the first quadrangular area (112A).

FIG. 11 illustrates the tray (100) with the first, second, third and fourth quadrangular areas.

### DETAILED DESCRIPTION OF THE INVENTION

According to one aspect, a smart tray is provided. Commodities of various sizes may be kept on the tray. The tray is not designed to only fit commodities of predetermined sizes and/or shapes, but rather is designed to accommodate commodities of any size and/or shape.

According to one aspect, the tray has a panel and is adaptable to a size of at least one commodity such that the panel can engage with the commodity.

The panel may also be referred to as the “top of the tray”; however, the panel may comprise more than one level or tier, wherein one or more of the level/tiers may be engage-able with commodities.

The term “Engage” should be understood in a broad range, from: a) allowing contact of one or more components or items, such as the commodity, with the panel, such that the commodity is freely lying against the panel, i.e. not held to the panel and free to be moved in at least one direction parallel to a surface of the panel, to: b) fastened to the panel such that considerable force and/or manipulation is required to remove the commodity from the panel, for example such that a child cannot remove the commodity and optionally also cannot move the commodity in any direction parallel to the surface of the panel.

Various tray embodiments may each have different engagements for the same commodity, according to their designs, for example a tray for a family room may allow fastening spirit bottles to the tray whereas a tray for adults only may allow the same spirit bottles to be loosely laid on the tray so that the only force required to remove them from the tray is a lifting force against gravity.

In some embodiments, the panel includes at least one hole and/or slot.

In some embodiments, the tray further comprises at least one tray holder. In some embodiments, each at least one holder comprises at least one peg that is sized to engage with a hole or slot, e.g., snugly fit into one of the at least one hole, or having a neck that allows the peg to be slid along a slot but also generally having a width that generally prevents pulling the peg out of the slot. The peg may be of any shape and size as long as it fits the hole or slot. Likewise, the hole/slot may be of any shape and size, but preferably within the limitations stipulated above. In some embodiments, the shape of the hole is rounded; in some embodiments, the shape is round.

In some embodiments, the holders are made of a polymeric material, for example, polypropylene. Another part of the holder that does not fit into the at least one hole, i.e., that extends out of the panel surface when the holder is engaged with the panel, will be referred to as an “engagement region”.

In some embodiments, the tray further comprises a bottom part. In some further embodiments, the bottom part essentially matches the size and shape of the panel. In some embodiments, the bottom part comprises acrylonitrile butadiene styrene (ABS). The bottom part may also be referred to as a “tray base”.

Some tray embodiments comprise an electronic smart card or PCB hidden in the tray or in or on the tray base.

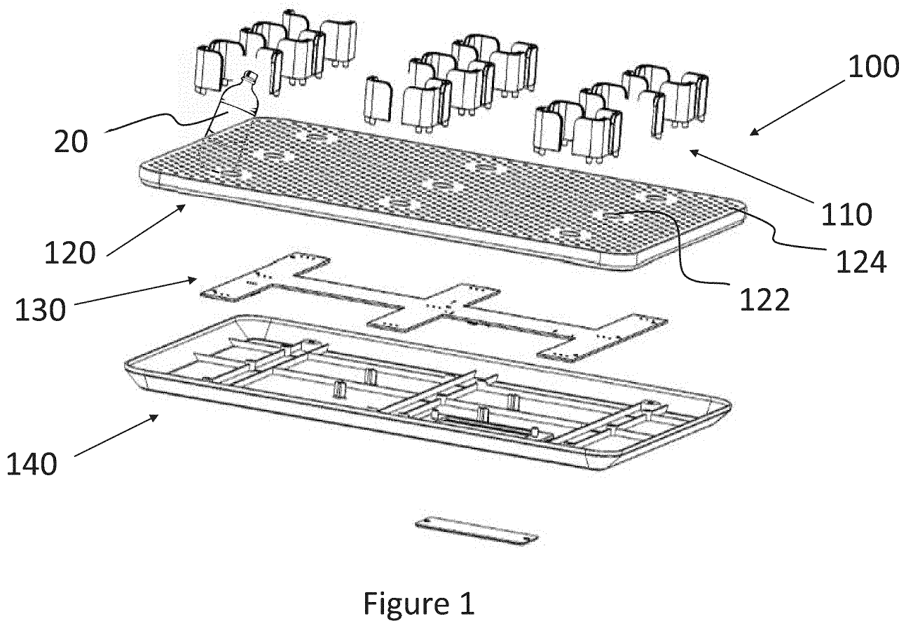

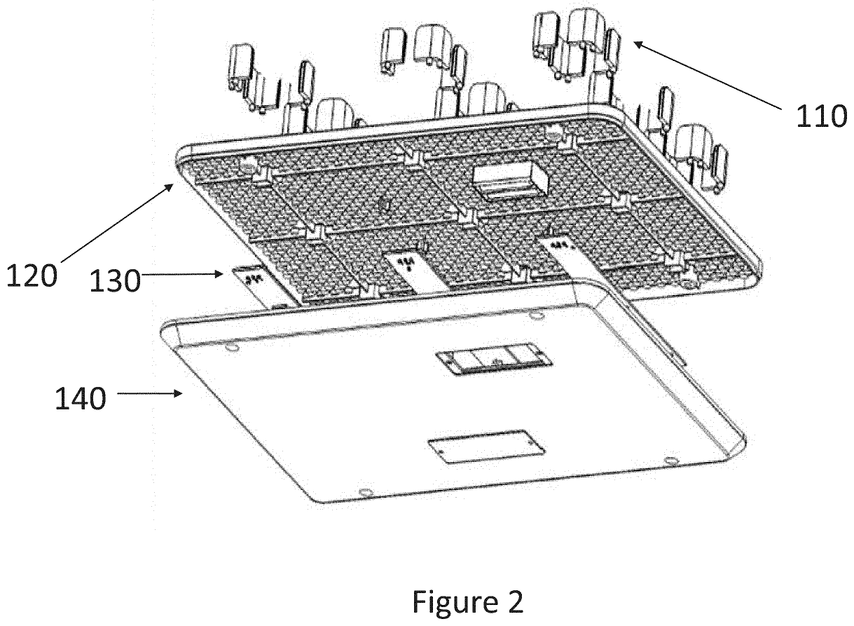

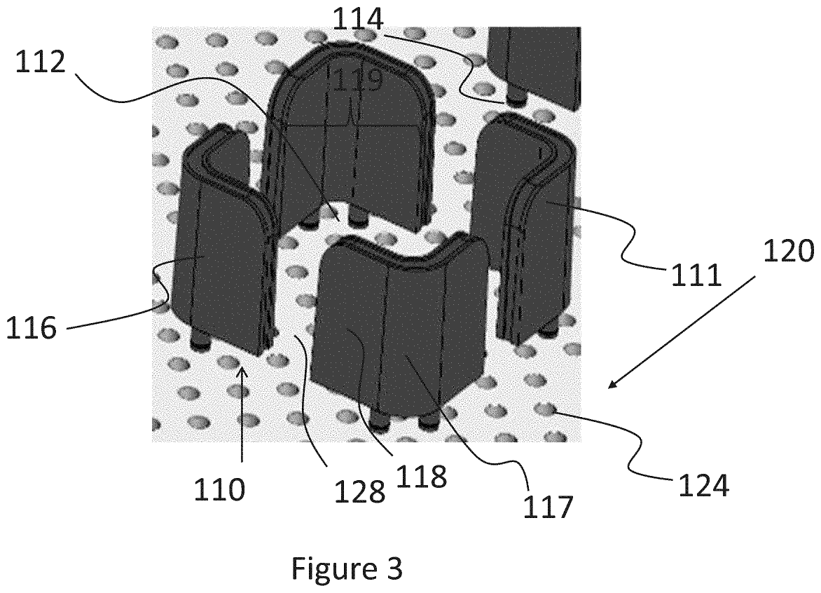

FIG. 1 illustrates an exploded elevated perspective view of the tray 100 that includes five major parts: holders 110, a panel 120, a PCB 130, a base 140 and a display, FIG. 2 is an exploded bottom perspective view of the tray 100 and FIG. 3 depicts the holders 110 in enlarge scale.

According to one aspect, the tray 100 is provided for displaying and selling products, wherein the tray 100 includes an upper panel 120, and the user or the hotel employee can place on the tray the products 20 for sale.

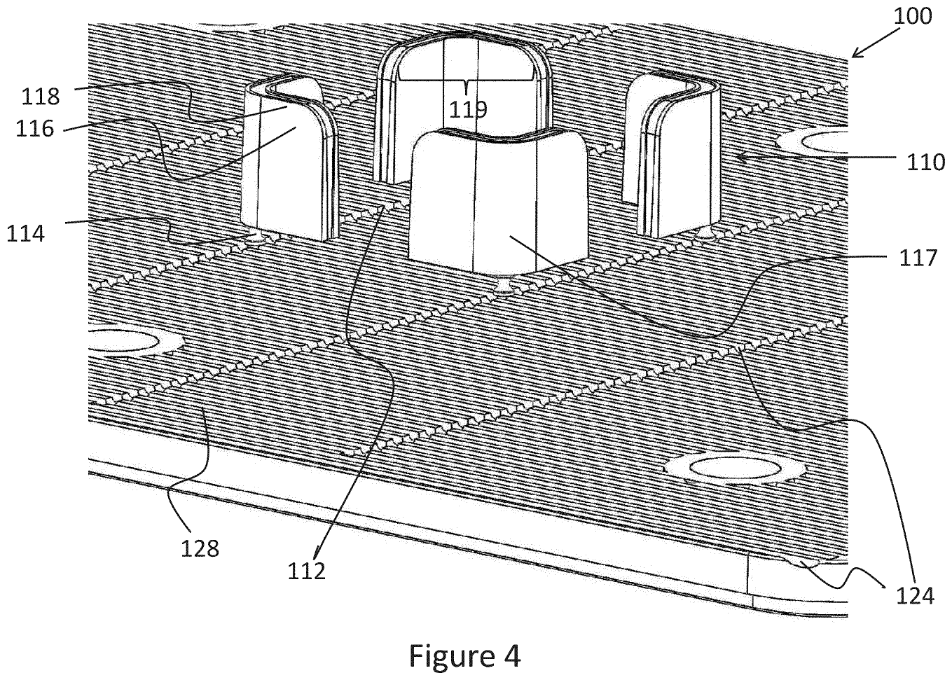

FIGS. 3 and 4 is enlarged depiction of the tray 100 in perspective views that comprising at least one upper panel 120 with several holes 124 (the term “holes” hereinafter and in the claims refers to holes as such and to equivalent means such as slots and the like, as depicted in FIG. 4 for example. The tray 100 further includes several tray holders 110. Each holder 110 has at least one peg 114 sized to fit into the slot or holes 124, and an engagement region 116, wherein the engagement region 116 extends out from the panel 120 when the peg 114 is inside the slot or hole 124.

FIGS. 3 and 4 show several holders 110 that are inserted in the upper panel, means that their pegs 114 are inserted inside holes and slots 124 of the panel, and the flat area 112 between the holders 110 define the area for a specific product that its shape is fit to that area. If the product 20 has a size and shape that substantially corresponds to the flat area 112 then the proximal holders 110 can demarcate exact are that fits that specific product 20, and by that such prevent any horizontal movement of the product 20.

The upper panel when in use comprises at least one essentially flat product placing area 112 and each engagement region 116 may comprise a corner 117; and may also include at least two wings 118 extending from the corner 117; wherein the corner 117 and at least the two wings 118 of a holder 110 define a product placing area 112.

In these embodiments 100 it is possible that at least one product placing area 112 is concave. In some other embodiments (not shown), the product placing area is convex i.e., the area of the product placing area 112 is curved so that a contour of a product having a substantially curved shape at/near its bottom (its contours near the product placing area 112 when laid on the surface) fairly matches the product placing area 112 contour and the engagement is thus extensive. In these embodiments 100 a first product placing area 112 may be perpendicular to another product placing area 112. This shape is can be a default shape that is generally most suitable to engage with products.

In some embodiments, the wings 118 of a holder 110 each comprise a non-engaging straight side 111. The straight side generally allows easily gripping of the holder 110 for insertion of the pegs 114 and removal of the holder 100 when a new product is added to the tray 100 and the area between adjacent holders 110 needs changing.

In some embodiments, the panel 120 comprises infra-red-transparent material such as an infra-red-transparent acrylic polymer. In some embodiments, there are lenses with sensors 122 embedded in the upper panel 120 that comprises the infra-red-transparent material. Infra-red radiation sources (not shown) within the tray 100 emit infra-red radiation through the lenses toward areas 112. If there is a product in place above or inside an area 112, then the light is reflected by the product back through at least one lens and is detected by at least one sensor (122) within the tray 100.

If the product is removed, for example by a purchaser, the infra-red radiation is not reflected or the reflected infra-red radiation is diminished in intensity, and the at least one sensor does not receive reflected infra-red radiation or receives less infra-red radiation. The PCB 130 is configured to allow distinguishing between the states when the product is in place and when the product is removed, based upon the signals that the sensor receives or does not receive.

Some products may be so large that they block radiation from more than one source. In such cases, the tray can be programmed to determine that only one product is removed when the radiation detected changes for more than one sensor. The programming of the trays can be performed remotely, for example via the internet, as is further described below.

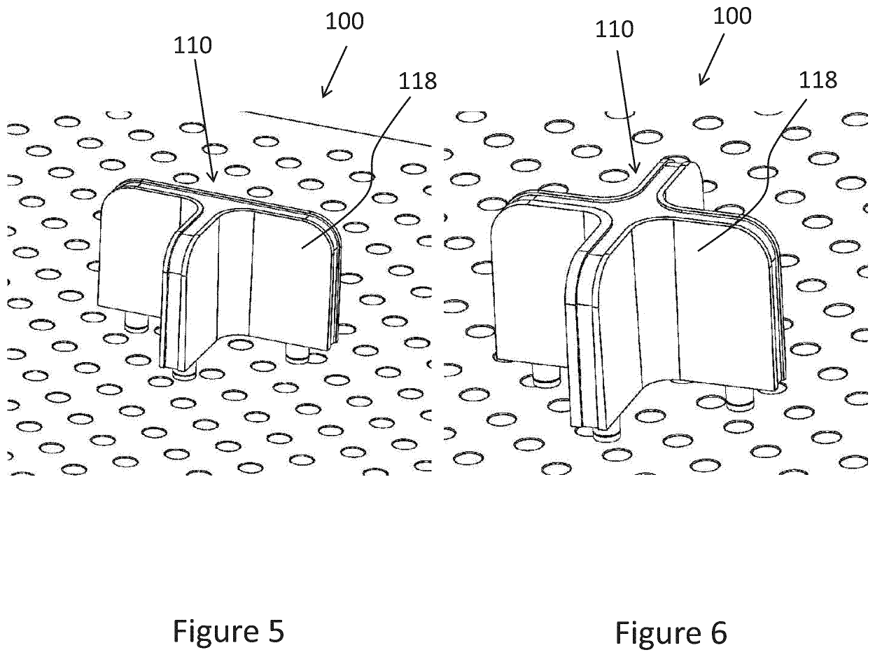

As shown in FIG. 5, in some embodiments 100 at least one of the holders 110 comprises three wings 118 perpendicular to each other. As shown in FIG. 6, in some embodiments 100 at least one of the holders 110 comprises four wings 118, wherein the holder 110 is cross-shaped.

The additional wings may allow engaging multiple adjacent commodities with minimum holders and with efficient use of space on the trays 100. However, the cross-shaped holders 110 are unsuitable for engagement of products near the edges or corners of the tray 100.

FIG. 3 depicts some embodiment, the location and the distance between adjacent holders 110 is adjustable, to better suit the shape and size of the specific product that the user (the Hotel owner for example, as a contrary to the guest) wishes to position in area around a specific sensor that enable a detection of the removal of a product.

The proximal holders 110 may be identical to or different from each other. Using identical holders has the advantage that it is easier to adjust the area 112 by relocating any holder/s 110.

In some embodiments, the holders are sufficiently large that two of them may be sufficient to hold the commodity. In some embodiments (not shown), at least some of the holders can hold in place a product, for example, if the panel 120 has upturned edges (not shown), a holder 110 adjacent to at least one edge may hold the product together with the edge.

Some embodiments comprise a combination of holders having various numbers of wings and/or profiles. A kit may be provided comprising a panel and spare holders.

Note that in the embodiment 100 shown in FIG. 1 the pegs 114 of at least one holder 110 extend from the corner 117 or from regions in between the corner 117 and the wings 118. This positioning of the pegs 114 may facilitate insertion of the pegs 114 into the holes 124, as opposed for example to embodiments wherein the pegs are further apart from each other. One peg, for example, extending from a corner of a holder, would allow to swivel the holder, which may be useful in allowing to hold commodities of irregular shape for example, and would require less holes/slots in the panel; on the other hand, such holders might be more fragile precisely due to their amenity to manipulation and having only one anchoring peg.

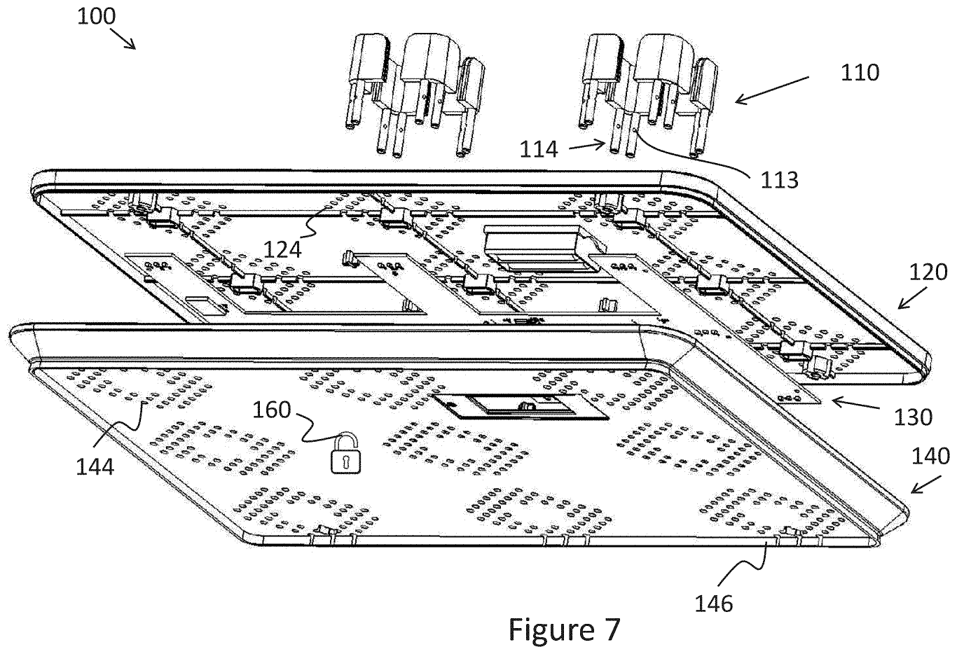

When the smart tray 100 is used in a location such as a hotel room it is usually preferable that the customer cannot move the holders 110. Accordingly, as shown in FIG. 7, some embodiments comprise at least one lock 360 for locking at least one holder 110 to the panel.

As shown in FIG. 7, the holders 110 have elongated pegs 114 that extend through holes 124 in the panel 120 and holes 144 in the base 140 so that the locks 360 can be placed under the base 140. The pegs 114 have holes 313 through which the locks 160 can be engaged. The base 140 of the tray 100 also has a lip 346 that allows the pegs 114 and locks 360 to be suspended when the base 340 is resting or laid up against a surface such as a table or wall.

The locking prevents either intentional or accidental removal or displacement of the holders 110. Similar embodiments will occur to the skilled in the art for manually locking the holders and should be considered as equivalent.

Similarly, embodiments with slots in the panel can have holders that are manually locked, but in other embodiments or optionally, the holders are remotely operable, e.g., electronically locked and unlocked, e.g., via commands passed from the cloud via a smart card or PCB 130. The holders 110 may be locked by a servo-mechanism electrically or electronically linked to the smart card/PCB, that together serve to control movement of the holders 110, or a separate mechanism may be used as a security feature, for example.

Many hotel rooms have a mini-bar, usually refrigerated, for storage of commodities for the customers. Such mini-bars are typically small or even miniature. Commercially available vending trays capable of sensing removal of some commodities might be too bulky to insert into such mini-bars. In some embodiments the trays are less than 30 mm thick; in some embodiments they are less than 20 mm thick; in some particular embodiments they are 15-20 mm thick. The reduced thickness may be achieved by having a thin PCB or smart card of a suitable shape such as shown in the figures. Furthermore, the infra-red sensors and emitters may be arranged so that together with the PCB they require minimal thickness of the tray.

The panel and tray base may be made of strong materials to allow them to be of minimal thickness. Such materials may be for example polycarbonate. The panel should comprise a material that is also essentially transparent to the radiation emitted by emitters in the tray, such as infra-red beams, both for radiation exiting the panel and for reflected light entering the panel, at suitable locations of the panel.

In some embodiments the holders 110 are made of polypropylene. The panel 120 is for example of a length of nearly 45 cm and a width of nearly 33 cm. The tray is very easy to detect (visible). The base of the tray 140 has shape and dimensions similar to the upper part 120. The two parts 120 and 140 contain an electrical circuit inside as part of the PCB 130.

Power to the electrical circuit and optics may be provided by one or more battery preferably situated between a panel 120 and a base 140. The panel 120 and a complementary base 140 may be affixed together, such as by gluing together, but in preferred embodiments the interior is more easily accessible to opening, such as having the parts connectable by screws or bolts, preferably having heads that require engagement by a special tool. In some embodiments there is a locking mechanism there between that requires access via the cloud to open.

In some embodiments the at least one peg 114 is hour-glass shaped and comprises a neck, wherein the neck extends throughout the slot when the at least one peg is engaged with the at least one slot. This feature helps to make the pegs robust while making the slots narrow. Such feature may help make the tray more robust and more tamper-resistant.

In some embodiments, Smart Tray management software transmits real-time alerts to a cloud management system to identify movements and changes. The management software interfaces with the hotel system and updates every change made to the smart tray in the room, in real time.

The product is automatically charged to the guest's room, with full details of the billing details (date, time, product and price), cosmetics, etc.

In some embodiments (not shown), the tray is configured to allow communication with the cloud via the PCB. In some of these embodiments the optical components of the tray can be controlled and adjusted, for example, adjustments can be made to allow installing or using tiers above the panel, i.e., platforms above the panel having a similar structure to the panel for holding additional products. In such embodiments the tray may comprise further components to allow adjustment of the IR beams for their different distances/paths, for example by adding and using collimators and/or lenses and/or power sources.

Activation of the tray: The tray will start up as a secured access point, allowing any device to connect to it. The tray will provide IP address to connected clients through DHCP. In order to configure the tray, the client has to launch its configuration wizard by browsing to its web interface.

This will switch the tray into service mode without further steps.

Service mode: At the service mode startup, the tray will try to connect to its configured access point. After establishing the connection, the tray will start collecting reports after the device has been calibrated.

These reports can be accessed by the server using a predefined communication protocol.

Communication protocol (Service mode): Each tray may have a unique IP address, and will listen to HTTP GET requests from the server. The commands then will be sent to the tray using HTTP protocol.

The tray has a variety of available commands enabling: Calibration, reading of the system info, getting data reports, setup service, rebooting, and erasing or restoring the factory defaults. The tray will send the data according to the movement of the presented objects (commodities). Every change in the tray can be detected by the implanted inner sensors that can detect if there is an object blocking the sensors or not. When the object in removed, the tray will send the information, in order to charge the client.

System calibration: In some embodiments, the calibration is done using two different points. To calibrate successfully, both points have to be set. It is advised to calibrate the tray using one point as a reference of an empty tray, and the other point as a reference to a standard reflective object for example. When setting the minimal point of an empty tray, its weighed value is zero.

Read System Info: In some embodiments, the Read System Info command lets the server read the following information from the tray: 1) Firmware version, 2) UUID

Get report data: In some embodiments, while the tray is in use, it will collect commodity removal reports, and these reports can be read by the server. Once read, they will be cleared from the tray. A tray can store several reports at a time and should be queried for available reports using this command Often, the server will poll the tray at an interval.

Erase/Restore factory defaults: In some embodiments, this command will remotely erase the tray's configuration, and will reboot it. This command will also disconnect the server from the tray, and place it in a state that will require setup by accessing its AP Interface (a set of clearly defined methods of communication among various components).

According to one aspect the trays are configured to allow retrofitting them into or onto receptacles or devices that are enhanced as a result of the retrofitting. For example, the tray is easily insert-able into a typical mini-bar or small refrigerator. Typically, the retrofitting requires less than a minute to complete. In some embodiments an adaptor is provided which is configured to allow the easy retrofitting, such a clamp/s that firmly couples the tray to a shelf on a mini-bar.

In some embodiments a plurality of trays is provided to one location such as a hotel room. The PCB/smart card of each tray is uniquely identifiable by the server. Each tray may comprise an RFID tag which may be readable by a RFID reader, which may be provided to a user for secure and sole use of the tray. In some embodiments the receptacle/device has its own card/unique identity and the system is configured to allow accurately identifying the tray/s despite being coupled to the receptacle/device.

It is stressed that some tray embodiments do not require connection to the mains and thus a freely movable such as to various locations in a hotel room or in between rooms. However, in some embodiments the tray is lockable to prevent theft or unauthorized movement.

About terminology: In the discussion, unless otherwise stated, adjectives such as “substantially” and “about” that modify a condition or relationship characteristic of a feature or features of an embodiment of the invention, are to be understood to mean that the condition or characteristic is defined to within tolerances that are acceptable for operation of the embodiment for an application for which it is intended. It should be noted that the term “item” as used herein refers to any physically tangible, individually distinguishable unit of packaged or unpackaged good or goods. Positional terms such as “upper”, “lower” “right”, “left”, “bottom”, “below”, “lowered”, “low”, “top”, “above”, “elevated”, “high”, “vertical” and “horizontal” as well as grammatical variations thereof as may be used herein do not necessarily indicate that, for example, a “bottom” component is below a “top” component, or that a component that is “below” is indeed “below” another component or that a component that is “above” is indeed “above” another component as such directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both. “Coupled with” means indirectly or directly “coupled with”. It is important to note that the methods described above are not limited to the corresponding descriptions. For example, the method may include additional or even fewer processes or operations in comparison to what is described herein and/or the accompanying figures. In addition, embodiments of the method are not necessarily limited to the chronological order as illustrated and described herein.

It should be understood that where the claims or specification refer to “a” or “an” element or feature, such reference is not to be construed as there being only one of that element. Hence, reference to “an element” or “at least one element” for instance, may also encompass “one or more elements”.

Unless otherwise stated, the use of the expression “and/or” between the last two members of a list of options for selection indicates that a selection of one or more of the listed options is appropriate and may be made.

It is noted that the term “perspective view” as used herein may also refer to an “isometric view” and vice versa.

It should be appreciated that certain features which are, for clarity, described in the context of separate embodiments, may also be provided in combination in a single embodiment. Conversely, various features, which are, for brevity, described in the context of a single embodiment, example and/or option, may also be provided separately or in any suitable sub-combination or as suitable in any other described embodiment. Certain features described in the context of various embodiments are not to be considered essential features of those embodiments, unless the embodiment, example, and/or option are inoperative without those elements. Accordingly, features, structures, characteristics, stages, methods, modules, elements, entities or systems disclosed herein, which are, for clarity, described in the context of separate examples, may also be provided in combination in a single example. Conversely, various features, structures, characteristics, stages, methods, modules, elements, entities or systems disclosed herein, which are, for brevity, described in the context of a single example, may also be provided separately or in any suitable sub-combination.

It is noted that the term “exemplary” is used herein to refer to examples of embodiments and/or implementations, and is not meant to necessarily convey a more desirable use-case.

In alternative and/or other embodiments, additional, fewer, and/or different elements may be used.

Throughout this description, various embodiments may be presented in a range format. It should be understood that the description in range format is merely for convenience and brevity and should not be construed as an inflexible limitation on the scope of the embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include—where applicable—any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there-between.

While the aspects have been described with respect to a limited number of embodiments, these should not be construed as scope limitations, but rather as exemplifications of some of the embodiments.

We can describe the invention in other words, as follows:

The present invention refers to a sales tray for hotel rooms (100) that comprises:

(a) a top panel (120) with at least ten rows (71) of holes (124) wherein each row has at least ten holes. Is it possible to put more or less holes and rows.
(b) a base (140), on which the top panel is assembled in a way that create a space (72) between them in which electronic components (130) can be integrated.
(c) a first sensor (122A) that is fixed to a first hole (73A), a second sensor (122B) that is fixed to a second hole (73B), a third sensor (122C) that is fixed to a third hole (73C) and a fourth sensor (122D) that is fixed to a fourth hole (73D), wherein each sensor is designed to detect whether an object (74) is placed over it or not. It is possible to integrate more sensors or less than four on the tray and the sensors can be photoelectric sensors, pressure sensors, contact sensors and the like.
(d) nine demarcators (110), wherein each demarcator has an inserting peg (114) that is adapted and capable to be inserted into the holes on the top panel. The tray may include more or less demarcators, and each of them may have one or more pegs. The demarcators may be flat, T-Shape, Cross shape and etc.
(e) The demarcators are designed to enable the user to demarcate around each sensor a quadrangular area (112A) in a size (75A) that correspond with a packaging of a product (20A), wherein said demarcation can be done by inserting three demarcators or more into holes on at least three sides (76A) (76B) (76C) of said sensor. The demarcators are designed to enable the user also to re-demarcate around said sensor another quadrangular area (112B) in another size (75B) that correspond with a packaging of another product (20B), wherein said size can be different in terms of size from the other size.
(f) The demarcators are designed to enable the user to demarcate around the first sensor the quadrangular area (112A) in the size (75A) that correspond with the packaging of the product (20A), to demarcate around the second sensor the another quadrangular area (112B) in the another size (75B) that correspond with the packaging of the another product (20B), to demarcate around the third sensor a third quadrangular area (112C) in a third size (75C) that correspond with a packaging of a third product (20C), and to demarcate around the fourth sensor a fourth quadrangular area (112D) in a fourth size (75D) that correspond with a packaging of a fourth product (20D), wherein said size, said another size, said third size, and said fourth size, can be different in terms of size from each other.
(g) The sales tray is designed to enables the user to associate four different products with packaging in different sizes to said four rectangular areas, according to sizes of said packaging, and enables the user to associate each sensor to a particular product, wherein enabling the user to monitor at the same time a removal of each particular product from its associated rectangular area, according to operation and detection of the sensors.

The present invention refers also to a method for demarcating and re-demarcating quadrangular areas in different sizes around sensors on a top panel of the sales tray for hotel rooms (100) that correspond with different packaging sizes of products, and this method comprises:

(a) Providing the sales tray for hotel rooms as described above.
(b) demarcating around the first sensor the quadrangular area (112A) in the size (75A) that correspond with the packaging of the product (20A), around the second sensor the another quadrangular area (112B) in the another size (75B) that correspond with the packaging of the another product (20B), around the third sensor a third quadrangular area (112C) in a third size (75C) that correspond with a packaging of a third product (20C), and around the fourth sensor a fourth quadrangular area (112D) in a fourth size (75D) that correspond with a packaging of a fourth product (20D), wherein said size, said another size, said third size, and said fourth size, can be different in terms of size from each other; and
(c) associating four different products with packaging in different sizes to said four rectangular areas, according to sizes of said packaging, and associating each sensor to a particular product, wherein enabling the user to monitor at the same time a removal of each particular product from its associated rectangular area, according to operation and detection of the sensors.

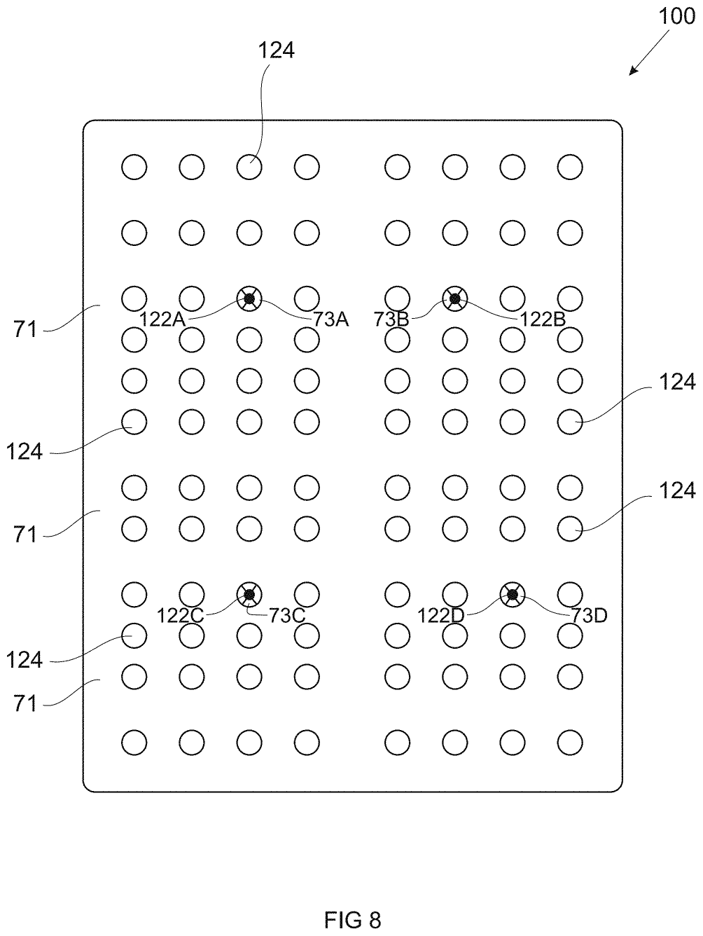

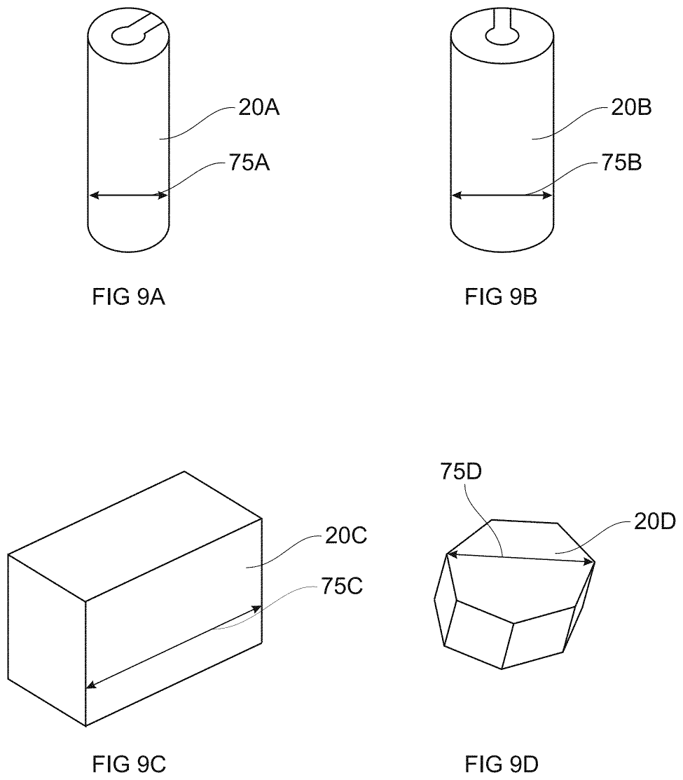

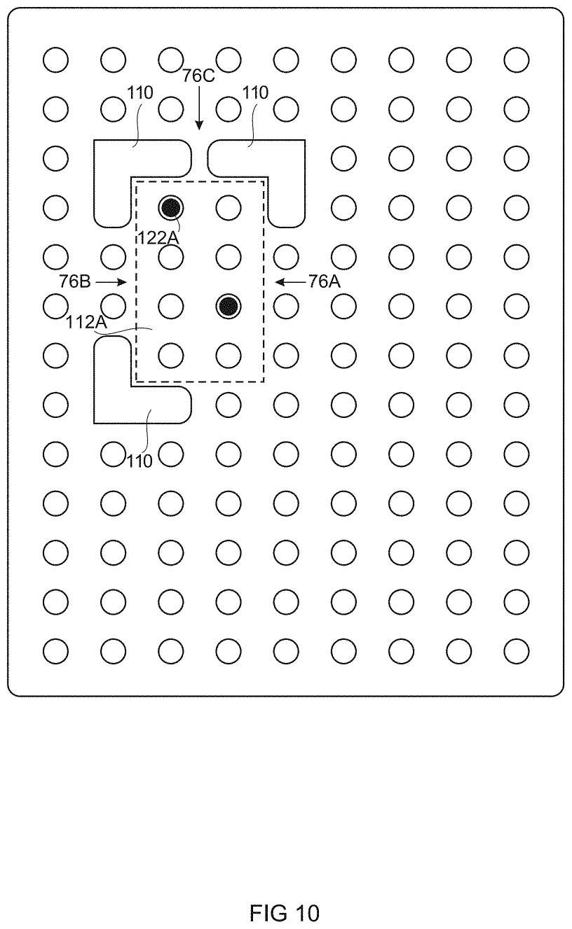

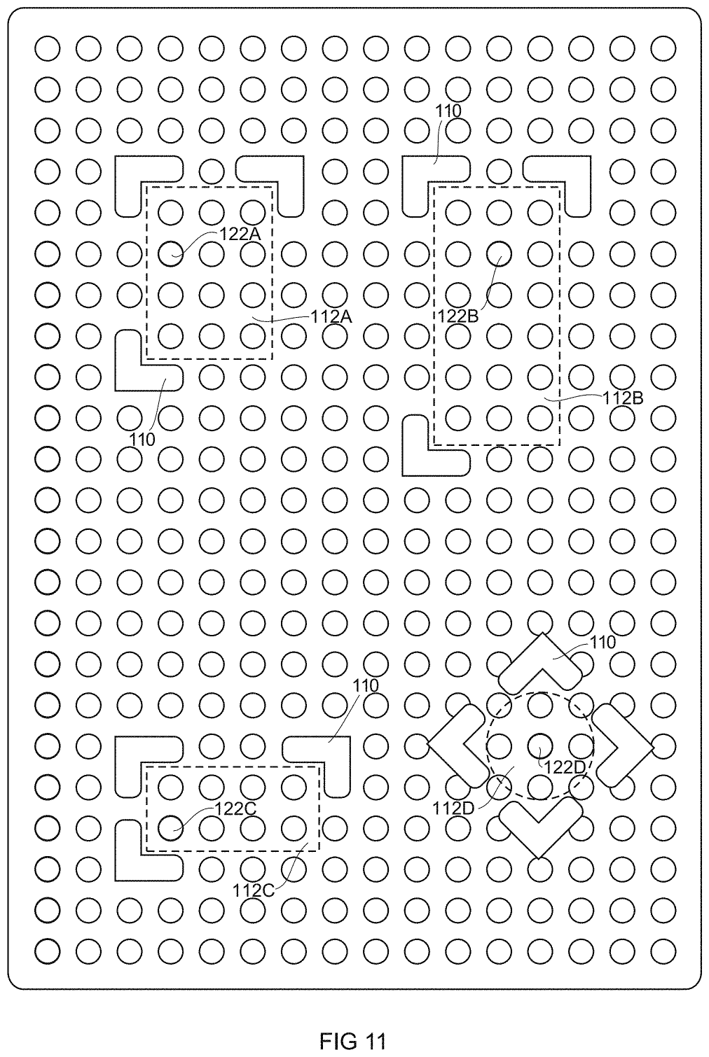

FIG. 8 depicts the tray (100) with its four sensors; FIGS. 9a, 9b, 9c and 9d depict few kinds of products (20a) (20b) (20c) (20d), FIG. 10 illustrates the tray (100) with the first quadrangular area (112A), and FIG. 11 illustrates the tray (100) with the first, second, third and fourth quadrangular areas.

One of the objectives of the invention is to enable the hotel to place on the tray few different products, usually in different shape and size, to place each product on a particular sensor and associate each product to its associated sensor. The demarcation around each sensor according to the size and shape of each product is designed to enable the hotel employee to place the products in the correct order, each product on the sensor associated with it, and to make the guest put the product back in place when he took it for a moment to test it, so that the monitoring will be done properly.

What is claimed is:

1. A sales tray for hotel rooms, comprising:
a top panel with at least ten rows of holes wherein each row has at least ten holes;
a base, on which the top panel is assembled in a way that create a space between them in which electronic components can be integrated;
a first sensor that is fixed to a first hole, a second sensor that is fixed to a second hole, a third sensor that is fixed to a third hole and a fourth sensor that is fixed to a fourth hole, wherein each sensor is designed to detect whether an object is placed over it;
nine demarcators, wherein each demarcator has an inserting peg that is adapted and capable to be inserted into the holes on the top panel;
wherein said demarcators are designed to enable a user to demarcate around each sensor a quadrangular area in a size that correspond with a packaging of a product, wherein said demarcation can be done by inserting three demarcators or more into holes on at least three sides of said sensor;
wherein said demarcators are designed to enable the user to re-demarcate around said sensor another quadrangular area in another size that correspond with a packaging of another product, wherein said size can be different in terms of size from the another size;
wherein said demarcators are designed to enable the user to demarcate around the first sensor said quadrangular area in the size that correspond with the packaging of the product, to demarcate around the second sensor the another quadrangular area in the another size that correspond with the packaging of the another product, to demarcate around the third sensor a third quadrangular area in a third size that correspond with a packaging of a third product, and to demarcate around the fourth sensor a fourth quadrangular area in a fourth size that correspond with a packaging of a fourth product, wherein said size, said another size, said third size, and said fourth size, can be different from each other, in terms of size; and
wherein said sales tray is designed to enables the user to associate the four different products with packaging in different sizes to said four rectangular areas, according to sizes of said packaging, and enables the user to associate each sensor to a particular product, wherein enabling the user to monitor at the same time a removal of each particular product from its associated rectangular area, accordance to operation and detection of the sensors.

2. A method for demarcating and re-demarcating quadrangular areas in different sizes around sensors on a top panel of a sales tray for hotel rooms that correspond with different packaging sizes of products, comprising:
Providing the sales tray for hotel rooms that comprises:
a top panel with at least ten rows of holes wherein each row has at least ten holes;
a base, on which the top panel is assembled in a way that create a space between them in which electronic components can be integrated;
a first sensor that is fixed to a first hole, a second sensor that is fixed to a second hole, a third sensor that is fixed to a third hole and a fourth sensor that is fixed to a fourth hole, wherein each sensor is designed to detect whether an object is placed over it;
nine demarcators, wherein each demarcator has an inserting peg that is adapted and capable to be inserted into the holes on the top panel;
wherein said demarcators are designed to enable a user to demarcate around each sensor a quadrangular area in a size that correspond with a packaging of a product, wherein said demarcation can be done by inserting three demarcators or more into holes on at least three sides of said sensor;
wherein said demarcators are designed to enable the user to re-demarcate around said sensor another quadrangular area in another size that correspond with a packaging of another product, wherein said size can be different in terms of size from the another size;
demarcating around the first sensor the quadrangular area in the size that correspond with the packaging of the product, around the second sensor the another quadrangular area in the another size that correspond with the packaging of the another product, around the third sensor a third quadrangular area in a third size that correspond with a packaging of a third product, and around the fourth sensor a fourth quadrangular area in a fourth size that correspond with a packaging of a fourth product, wherein said size, said another size, said third size, and said fourth size, can be different in terms of size from each other; and
associating four different products with packaging in different sizes to said four rectangular areas, according to sizes of said packaging, and associating each sensor to a particular product, wherein enabling the user to monitor at the same time a removal of each particular product from its associated rectangular area, accordance to detection of the sensors.
